(19) United States
(12) Patent Application Publication
(10) Pub. No.: US 2016/0244369 A1
(43) Pub. Date: Aug. 25, 2016

(54) WATERPROOF MORTAR COMPOSITION AND METHOD FOR PREPARING SAME

(71) Applicant: HURIS CO., LTD., Incheon (KR)

(72) Inventor: KI-CHEOL NAM, Incheon (KR)

(21) Appl. No.: 14/890,909

(22) PCT Filed: Oct. 23, 2014
(86) PCT No.: PCT/KR2014/010019

§ 371 Date: Nov. 13, 2015

(30) Foreign Application Priority Data
Oct. 25, 2013 (KR) 10-2013-0128037

(51) Int. Cl. C04B 28/30

(52) U.S. Cl. CPC C04B 28/30; C04B 2111/0075

(57) ABSTRACT

The present invention relates to a waterproof mortar composition, which can exhibit an excellent adhesive performance with conventional concrete and maintain good workability, and obtain a required strength in a short time such that the composition is suitable for repairing a deteriorated or partially damaged defective part of the road and shows an effective waterproof property for structures including a road. The waterproof mortar composition, according to the present invention, comprises: 15-40 wt % of preprocessing silica; 25-45 wt % of an inorganic binding material; 15-25 wt % of silica; 5-10 wt % of phosphate; 2-10 wt % of aluminum oxide; and 2-10 wt % of magnesium oxide. According to the elements of the waterproof mortar composition, the present invention is capable of preventing cracks and separation of the construction part; and improving the adhesion with an attachment and at the same time, improving waterproof efficiency by filling a silane-based resin in an air-tight manner.

### TECHNICAL FIELD

The present invention relates to a waterproof mortar composition, which can exhibit, air excellent adhesive performance with conventional concrete and maintain good workability, and obtain a required strength in a short time such that the composition is suitable for repairing a

deteriorated or partially damaged defective part of the road and shows an effective waterproof property for structures including a road, and a method for preparing the same.

### DISCUSSION OF RELATED ART

Generally, waterproof agents are a material to allow something a waterproof property and come in various types including waterproof cloth or something of having hemp or cotton cloth impregnated with, e.g., asphalt, those applied on the surface of concrete blocks or asphalt roofing or mortar/concrete products or cloth, paper, or fabric products to provide water repellency, or those for increasing waterproof property and water tightness as a solvent, such as those mixed with mortar or concrete.

Among them, regular waterproof agents used for concrete products or structures contain various organic or inorganic chemicals to form a waterproof layer on the base material where the waterproof agent is applied, thereby allowing the concrete to have a waterproof property.

Recently, waterproof agents formed of inorganic substances or containing inorganic substances as main substance are being released, examples of which are as follows.

First, Korean Patent No. 474166 discloses a ceramic waterproofing method and waterproof agent used for the same, wherein the waterproof agent includes an inorganic material consisting of 40% of jade powder, 20% of silica, 30% of Portland cement, 3% of methylcellulose, and a curing agent consisting of 7% of oxide, 20% of SBR latex, 20% of EVA bonding agent, 3% of sodium benzonitrile, and 57% of distilled water.

Second, Korean Patent No. 668077 discloses concrete and an inorganic surface penetrating agent for protecting a concrete structure using the same, wherein the surface penetrating agent includes 10 parts by weight to 50 parts by weight of any one organic solvent selected from the group consisting of glycol ether, hydrocarbon, glycol ether ester, and C1 to C4 of alcohol relative of 100 parts by weight of the composition consisting of 50 wt % to 90 wt % of ethylsilicate monomer partially hydrolyzed and adjusted; and an organic solvent of 10 parts by weight to 50 parts by weight selected from the group consisting of hydrophobic silane, oligomer siloxane, and lower-molecular weight polysiloxane.

The general concrete waterproof agents, however, simply form an organic waterproof layer on the surface, and such is thus subject to reduced adhesivity, durability, and acid-resistance as time goes by, is vulnerable to organic solvents, and suffers from low thermal resistance and weather resistance, so that the durability and adhesivity may be further deteriorated when they are exposed to ultraviolet rays.

Waterproof agents adopting inorganic substances as main substance may advantageously have an effect, of impregnation into the concrete base material but has a plenty of limitations on workability due to including chemicals like normal waterproof agents—for example, the work should wear protective clothes; the work should be done in an open place or when in a closed place, the working time should be strictly observed.

### PRIOR TECHNICAL DOCUMENTS

### Patent Documents

(Patent Document 0001) Korean Patent No. 10-0463494 (registered on Dec. 16, 2004)

(Patent Document 0002) Korean Patent No. 10-0788021 (registered on Dec. 14, 2007)

(Patent Document 0003) Korean Patent Application Publication No, 10-1999-0048208 (published on Jul. 5, 1999)

### SUMMARY

The present invention aims to provide a waterproof mortar composition that prevent the constructed area from cracking or floating off while increasing adhesiveness to the coated object and may improve waterproof efficiency by the airtight filling of a silane-based resin.

Further, the present invention aims to provide an eco-friendly waterproof mortar composition that does not include lime unlike the existing Portland cement and may increase strength while protecting the mortar surface.

Further, the present invention aims to provide a waterproof mortar composition that contains a phosphate with excellent initial and later strengths, delayed quick-setting property, and more flowability.

The present invention is not limited to the foregoing objects, and other objects will be apparent to one of ordinary skill in the art from the detailed description of the present invention.

According to the present invention, a waterproof mortar composition comprises 15 wt % to 40 wt % of preprocessing silica, 25 wt % to 45 wt % of an inorganic binding material, 15 wt % to 25 wt % of silica, 5 wt % to 10 wt % of phosphate, 2 wt % to 50 wt % of aluminum oxide, and 2 wt % to 10 wt % of magnesium oxide.

The preprocessing silica may be formed of silane, water, and silicon dioxide.

The silane and the water may be mixed in a weight ratio of 0.2:0.8 through 0.8:0.2.

The silicon dioxide may have a granularity of 20 to 200 meshes.

The silane of 10 wt % to 30 wt % may be included relative to the weight of the silicon dioxide.

The silane may include at least one or more selected from the group consisting of tetramethoxysilane, tetraethoxysilane, methyltrimethoxysilane, methyltriethoxysilane, methylisopropoxysilane, phenyltrimethoxysilane, phenyltriethoxysilaoe, dimethyldimethoxysilane, dimethyldtethoxysilane, diphenyldimethoxysilane, diphenyldiethoxysilane, methylphenyldimethoxysilane, or a combination thereof.

The inorganic binding material may include blast furnace slag and fly ash.

The inorganic binding material may include blast furnace slag and fly ash added in a weight ratio of 80:20 through 20:80.

The phosphate may be potassium monophosphate.

The waterproof mortar composition may further comprise calcium silicate.

The calcium silicate of 20wt % to 35wt % may be included relative to the overall weight of the phosphate.

According to the present invention, a method for preparing a waterproof mortar composition may comprise spraying a solution in which, silane and water are mixed in a ratio of 0.2:0.8 through 0.8:0.2 to silicon dioxide (SiO2) having a granularity of 20 to 200 meshes to coat a surface of the silicon dioxide (SiO2), then drying at 80° C. to 120° C. for one to five hours to prepare preprocessing silica, and then mixing the preprocessing silica with 25 wt % to 45 wt % of an inorganic binding material 15 wt % to 25 wt % of silica, 5 wt % to 10 wt % of phosphate, 2 wt % to 10 wt % of aluminum oxide, and 2 wt % to 10 wt % of magnesium oxide.

The waterproof mortar composition may further include calcium silicate.

20 wt % to 35 wt % of the calcium, silicate may be included relative to the total weight of the phosphate.

According to the present invention, the waterproof mortar composition may prevent the constructed area from cracking or floating off while increasing adhesiveness to the coated object and may improve waterproof efficiency by the airtight filling of a silane-based resin.

According to the present invention, the waterproof mortar composition is eco-friendly because it does not include lime unlike the existing Portland cement and may increase strength while protecting the mortar surface.

According to the present invention, the waterproof mortar composition may provide excellent initial and later strengths, delayed quick-setting property, and more flowability.

It will be appreciated that embodiments of the present invention may provide other various effects not specifically mentioned herein.

### DETAILED DESCRIPTION OF EXEMPLARY EMBODIMENTS

Advantages and features of the present invention and methods for achieving the same will be apparent from the detailed description of embodiments of the present invention. However, the present invention may be embodied in other forms without limited to the embodiments set forth herein. Rather, the embodiments set forth herein are provided merely to convey the scope of the present invention to one of ordinary skill in the art so that the present disclosure may be thoroughly understood by one of ordinary skill in the art.

The terms used herein are provided simply for description purposes and are not intended to limit the present invention. A singular form includes a plural form unless clearly stated otherwise. It should be appreciated that as used herein, the terms “include” or “have” simply indicates that there is a feature, numeral, step, operation, component, part, or a combination, thereof as disclosed herein and does not exclude the probability of the presence or adding one or more other features, numerals, steps, operations, components, parts, or combinations thereof.

Unless defined otherwise, all the terms used herein including technical or scientific terminology have the same meanings as those generally understood by one of ordinary skill in the art. The terms defined in the dictionary regularly used should be construed to have the meaning identical to that in the context of the related art, and is not ideally or overly formally interpreted unless clearly defined otherwise.

Hereinafter, preferred embodiments of waterproof mortar compositions according to the present invention are described.

According to a preferred embodiment of the present invention, a waterproof mortar composition contains 15 wt % to 40 wt % of preprocessing silica, 25 wt % to 45 wt % of an inorganic binding material, 15 wt % to 25 wt % of silica, 5 wt % to 10 wt % of phosphate;

2 wt % to 10 wt % of aluminum oxide, and 2 wt % to 10 wt % of magnesium oxide.

The preprocessing silica is a main component that allows the waterproof cement a waterproof effect, according to the present invention. The processing silica is surface-coated with silane, and dry-processed and mixed between phosphate cement and normal silica to prevent water from coming in tiny gaps. The processing silica homogeneously mixed exhibits a hydrophobic property, achieving a waterproof effect. Preferably, the amount of the preprocessing silica used is 15 wt % to 40 wt %. If the amount of the preprocessing silica is less than 15 wt %, a deteriorated waterproof effect may be presented, and if the amount of the preprocessing silica is more than 40 wt %, the waterproof mortar prepared may suffer from a reduced strength.

The preprocessing silica may be prepared by spraying a solution in which silane and water are mixed in a ratio of 0.2:0.8 through 0.8:0.2 to silicon dioxide (SiO2) having a granularity of 20 to 200 meshes to coat a surface of the silicon dioxide (SiO2) and then drying at 80° C. to 120° C. for one to five hours.

10 wt % to 30 wt % of silane may be contained relative to the weight of silicon dioxide. The silane may include one or more selected from the group consisting of tetramethoxysilane, tetraethoxysilane, methyltrimethoxysilane, methyltriethoxysilane, methylisopropoxysilane, phenyltrimethoxysilane, phenyltriethoxysilane, dimethyldimethoxysilane, dimethyldiethoxysilane, diphenyldimethoxysilane, diphenyldiethoxysilane, methylphenyldimethoxysilane, or a combination thereof. The silane is used to form a waterproof layer on the mortar while giving the nature of a coat. If the amount of the silane is more than 30 wt % relative to the total amount of the preprocessing silica component, the coat becomes too strong, and if the amount of the silane is less than 10 wt %, the coat becomes too weak.

The water is used to facilitate to spray the silane. Since the silane causes a complete hydrolysis reaction when mixed with water, it is stirred or mixed for three to fifteen minutes. At this time, an acid such as hydrochloric acid, sulfuric acid, or citric acid may be used as a pH adjuster to adjust the same to pH 4 to 6, thereby accelerating the hydrolysis.

According to the present invention, the silane and water are mixed together and are then spray into silicon dioxide (SiO2) having a granularity of 20 to 200 meshes to coat the surface of the silicon, dioxide (SiO2). A sprayer typically used in the art to which the present, invention pertains may be used to spray a mixture of silane and water in a ratio of 10 wt % to 30 wt % relative to the weight of the silicon dioxide (SiO2), If the mixture of silane and water departs, in the amount sprayed, from the range, the mixture might not be fully coated on the surface of the silicon dioxide (SiO2) or run down the surface, thus leading to the reduction in amount or an uneconomical result.

The surface-coated silicon dioxide (SiO2) is dried by a drier at 80° C. to 120° C. for one to five hours to thereby prepare preprocessing silica. Any dryer may be used which is typically used in the art to which the present, invention pertains. The temperature and time dried are not specifically limited, but it is effective to dry at 80° C. to 120° C. for one to five hours. The time dried may be adjusted in a reverse proportion, to the temperature dried. However, it is not preferable to leave the silane coated on the surface of the silicon dioxide (SiO2) to be deformed by a higher temperature.

25 wt % to 45 wt % of inorganic binding material may be included according to the present invention. According to the present invention, the inorganic binding material may include a blast furnace slag and fly ash. Preferably, the inorganic binding material may contain blast furnace slag and fly ash added in a weight ratio of 80:20 through 20:80. If the amount of blast furnace slag used is more than the range, such problems may arise as difficulty in achieve a compression strength, quick setting and lack of flowability, and the occurrence of compression and cracks. If the amount of fly ash used is in excess of the range, a reduced compression strength may be presented due to lower reactivity even though such issues as cracks, quick setting or lack of flowability do not arise.

The silica is a component used as a filler to reinforce the mechanical strength of the waterproof mortar according to the present invention. Silica is a compound of oxygen and silicon and is also called silicic acid anhydride. Silica presents a lower thermal expansion rate and excellent mechanical strength. Thus, according to the present invention, the silica may be mixed in the waterproof mortar particularly to increase the mechanical strength of the waterproof mortar to thereby reinforce the withstandability of the mortar structure and to allow the waterproof mortar an increased reinforcing property. Particularly, aluminum silicate, magnesium silicate, or calcium silicate may be used as the silica. It is preferable to mix and use the silica in a range of 15 wt % to 25 wt % relative to the total weight of the waterproof mortar. If the amount of the silica is less than 15 wt %, the reinforcing effect may be tiny, and if the amount of the silica is more than 25 wt %, the price of the waterproof mortar may be sharply increased to render it difficult to make it commercially available.

5 wt % to 10 wt % of the phosphate may be used. If the amount of the phosphate added is less than 5 wt %, the mixture of the inorganic binding material may be quickly set and hardened before formed or may cause cracks due to the quick hardening, resulting in the failure to achieve a higher level of compression strength (defined to be an ultra-high strength of 80 Mpa or higher). If the amount of the phosphate is more than 10 wt %, the price of the product may be too increased while no further enhancement in compression strength is achieved.

According to the present invention, potassium monophosphate, potassium diphosphate, potassium triphosphate, sodium monophosphate, sodium diphosphate, sodium triphosphate, aluminum phosphate, zinc phosphate, ammonium polyphosphate, sodiumhexametaphosphate, calcium monophosphate, calcium diphosphate, or calcium triphosphate may be used as the phosphate.

Adding the phosphate, the initial set time of the binding material may be verified to be extended. Upon manufacture of the product, the extended time may lead to the formation of the product and allow the materials a rearrangement time to suppress-cracks from occurring in the product. Further, it can be shown that the initial set time may be extended in various manners depending on the type of phosphate used, and such advantages may broaden applicability according to the site.

According to the present invention, the waterproof mortar may further include calcium silicate, 20 wt % to 35 wt % of the calcium silicate may be included relative to the total weight of the phosphate. The calcium silicate is used to enhance the properties of spraying and pumping the phosphate. The mortar formed of the phosphate tends to be rapidly cured and may bear chemically excellent stability and compression strength, but due to the quickly curing property, the mortar formed of the phosphate may give a poor spraying and pumping property. Accordingly, adding the calcium silicate of 20 wt % to 35 wt % relative to the total weight of the phosphate may allow the mortar formed of the phosphate an enhanced spraying and pumping property.

2 wt % to 10 wt % of the aluminum oxide may be included. The aluminum oxide may be used to very quickly core the waterproof mortar according to the present invention. The aluminum oxide features a short curing time and robustness to water. Further, the aluminum oxide may protect the mortar coating and internal rebars by its coating, and the aluminum oxide coating may block air penetration to produce a high anti-corrosion and waterproof property.

2 wt % to 10 wt % of the magnesium oxide may be included. The magnesium oxide may determine the reaction speed. Since the reaction speed is adjusted by the magnesium oxide, the magnesium oxide may prevent sharp heat-up upon preparing the waterproof mortar.

Now described in detail is a method for preparing a waterproof mortar composition according to the present invention.

In the method for preparing the waterproof mortar composition according to the present invention, the silane and the water may be mixed together in a weight ratio of 0.2:0.8 through 0.8:0.2, The silane includes at least one or more selected from the group consisting of tetramethoxysilane, tetraethoxysilane, methyltrimethyoxysilane, methyltriethoxysilane, methylisopropoxysilane, phenyltrimethoxysilane, phenyltriethoxysilane, dimethyldimethoxysilane, dimethyldiethoxysilane, diphenyldimethoxysilane, diphenyldiethoxysilane, methylphenyldimethoxysilane, or a combination thereof.

Next, the mixture of silane and water in a predetermined ratio was sprayed to silicon dioxide (SiO2) with a granularity of 20 to 200 meshes to coat the surface of the silicon dioxide (SiO2).

Then, the silane and water were coated on the surface of the silicon dioxide (SiO2) and were then dried by a drier at 80° C. to 120° C. for one to five hours, thereby preparing preprocessing silica.

Subsequently, the preprocessing silica was mixed with 25 wt % to 45 wt % of an inorganic binding material, 15 wt % to 25 wt % of silica, 5 wt % to 10 wt % of phosphate, 2 wt % to 10 wt % of aluminum oxide, and 2 wt % to 10 wt % of magnesium oxide, producing waterproof mortar.

Here, a mixture of blast furnace slag and fly ash may be used as the inorganic binding material. Preferably, the blast furnace slag and the fly ash may be added in a weight ratio of 80:20 through 20:80. Particularly, aluminum silicate, magnesium silicate, or calcium silicate may be used as the silica.

Hereinafter, a preferred embodiment of a method for preparing waterproof mortar according to the present invention is described in greater detail.

### First Embodiment

Methyltrimethoxysilane(methyl trimethoxysilane) and water were put in a stirrer in a weight ratio of 1:1 and stirred and mixed for ten minutes, and the resultant solution was sprayed to silicon dioxide (SiO2) with an average granularity of 100 meshes to coat the surface of the silicon, dioxide (SiO2), then dried by a drier at 100° C. for three hours to prepare preprocessing silica, and then mixed with 3 5wt % of an inorganic binding material, 20 wt % of silica, 8 wt % of phosphate, 5 wt % of aluminum oxide, and 5 wt % of magnesium oxide to prepare a waterproof mortar composition. Water of 20 wt % was added to the waterproof mortar composition relative to the total weight of the waterproof mortar composition prepared, thereby producing waterproof mortar according to the present invention.

### First Experimental Example

A water permeability test was performed on the waterproof mortar prepared in the first embodiment by a KS F 2262 method. In other words, a 40 cm×40 cm-sized plate-shaped sample (cured for ten days) was prepared using the waterproof mortar according to the present invention, and a 6 cm-diameter pipe was filled with water at a height of 20 cm, and in 24 hours, any trace of water permeability was observed at an opposite side. As a result, no trace was observed.

### Second Experimental Example

A test as to whether cracks arise was conducted on the waterproof mortar prepared in the first embodiment by a KS F 2262 method. In other words, the waterproof cement according to the present invention was applied to a one-centimeter thickness on a 10 cm×10 cm-sized plate and cured at room temperature in a vertical direction for seven days, and after the seven days elapsed, whether there are cracks on the surface was verified. As a result, it could be verified that no surface cracks occurred even twelve days after the curing.

### Third Experimental Example

A plate-shaped sample was prepared using the waterproof cement prepared in the first embodiment, and was subjected to repeated water immersion and drying at room temperature to form a condition for an antirust test. As a result, it could be verified that the surface was rusted but not inside.

While the present invention has been shown and described with reference to exemplary embodiments thereof it will be apparent to those of ordinary skill in the art that various changes in form and detail may be made thereto without departing from the spirit and scope of the present invention as defined by the following claims.

What is claimed is:

1. A waterproof mortar composition, comprising:
15 wt % to 40 wt % of preprocessing silica;
25 wt % to 45 wt % of an inorganic binding material;
15 wt % to 25 wt % of silica;
5 wt % to 1 0wt % of phosphate;
2 wt % to 10 wt % of aluminum oxide; and
2 wt % to 10 wt % of magnesium oxide.

2. The waterproof mortar composition of claim 1, wherein the preprocessing silica is formed of silane, water, and silicon dioxide.

3. The waterproof mortar composition of claim 2, wherein the silane and the water are mixed in a weight ratio of 0.2:0.8 through 0.8:0.2.

4. The waterproof mortar composition of claim 2, wherein the silane of 10 wt % to 30 wt % is included relative to the weight of the silicon dioxide.

5. The waterproof mortar composition of claim 4, wherein the silane includes at least one or more selected from the group consisting of tetramethoxysilane, tetraethoxysilane, methyltrimethoxysilane, methyltriethoxysilane, methylisopropoxysilane, phenyltrimethoxysilane, phenyltriethoxysilane, dimethyidimethoxysilane, dimethyldiethoxysilane. diphenyldimethoxysilane, diphenyldiethoxysilane, methylphenyldimethoxysilane, or a combination thereof.

6. The waterproof mortar composition of claim 1, wherein the inorganic binding material includes blast furnace slag and fly ash added in a weight ratio of 80:20 through 20:80.

7. The waterproof mortar composition of claim 1, wherein the phosphate is potassium monophosphate.

8. The waterproof mortar composition of claim 1, further comprising calcium silicate.

9. The waterproof mortar composition of claim 8, wherein the calcium silicate of 20 wt % to 35 wt % is included relative to the overall weight of the phosphate.

10. A method for preparing a waterproof mortar composition, the method comprising:
spraying a solution in which silane and water are mixed in a ratio of 0.2:0.8 through 0.8:0.2 to silicon dioxide (SiO2) having a granularity of 20 to 200 meshes to coat a surface of the silicon dioxide (SiO2), then drying at 80 to 120° C for one to five hours to prepare preprocessing silica, and then mixing the preprocessing silica with 25 wt % to 45 wt % of an inorganic binding material, 15 wt % to 25 wt % of silica, 5 wt % to 10 wt % of phosphate, 2 wt % to 10 wt % of aluminum oxide, and 2 wt % to 10 wt % of magnesium oxide.
